(19) United States
(12) Patent Application Publication
(10) Pub. No.: US 2006/0165480 A1
(43) Pub. Date: Jul. 27, 2006

(54) Method for connecting structural sandwich plate members with channel-shaped connecting members

(75) Inventor: Stephen John Kennedy, Ottawa, ON (CA)

Correspondence Address: DARBY & DARBY P.C., P. O. BOX 5257, NEW YORK, NY, 10150-5257, US

(73) Assignee: Intelligent Engineering (Bahamas) Limited, Nassau (BS)

(21) Appl. No.: 10/549,009

(22) PCT Filed: Feb. 23, 2004
(86) PCT No.: PCT/GB04/00704

§ 371 Date: Sep. 13, 2005

(30) Foreign Application Priority Data
Mar. 18, 2003 (GB) 0306198.3

(51) Int. Cl. B25G 3/34

(52) U.S. Cl. 403/272

(57) ABSTRACT

To connect two structural sandwich plate members (10, 20), each is provided with a channel-shaped connecting member (14, 24) fitted between and projecting from the outer plates (11, 12, 21, 22). The two plate members (10, 20) are abutted and welds (31, 32) formed between the outer plates (11, 12, 21, 22).

The present invention relates to methods for connecting structural sandwich plate members which comprise two outer plates and a core of plastics or polymer material bonded to the outer plates with sufficient strength to substantially contribute to the structural strength of the member.

Structural sandwich plate members are described in U.S. Pat. No. 5,778,813 and U.S. Pat. No. 6,050,208, which documents are hereby incorporated by reference, and comprise outer metal, e.g. steel, plates bonded together with an intermediate elastomer core, e.g. of unfoamed polyurethane. These sandwich plate systems may be used in many forms of construction to replace stiffened steel plates and greatly simplify the resultant structures, improving strength and structural performance (stiffness, damping characteristics) while saving weight. Further developments of these structural sandwich plate members are described in International Patent Application WO 01/32414, also incorporated hereby by reference. As described therein, foam forms may be incorporated in the core layer to reduce weight and transverse metal sheer plates may be added to improve stiffness.

According to the teachings of WO 01/32414 the foam forms can be either hollow or solid. Hollow forms generate a greater weight reduction and are therefore advantageous. The forms described in that document are not confined to being made of lightweight foam material and can also be make of other materials such as wood or steel boxes.

International Patent Application WO 02/078948 is a further development of the concept of including hollow forms and describes forms that are easy to manufacture and assemble, in particular hollow elongate forms made from snap-together pieces are described.

To connect together two (or more) structural sandwich plate members, rolled or extruded members such as described in International Application PCT/GB02/00157 may be used. These members accommodate a wide variety of forms of join but each different arrangement of plate members requires a different joining member. British Patent Application GB-2 380 970-A describes a universal connector in the form of a solid bar of octagonal cross-section which is welded into the periphery of a structural sandwich plate member with part of the bar projecting out from between the faceplates of the structural sandwich plate member. Two (or more) plates with such connectors can be welded together in various different ways. This connector solves the problem of requiring many different members to join plate members in many different arrangements but is relatively heavy.

It is an aim of the present invention to provide a method of connecting structural sandwich plate members that uses a single, lightweight connector to connect plate members together.

According to the present invention, there is provided a method of connecting two structural sandwich plate members each of which comprises two outer plates and a core of plastics or polymer material bonded to the outer plates with sufficient strength to transfer shear forces therebetween, the method comprising:

providing in the edges of the structural sandwich plate members to be joined channel-shaped connecting members, the connecting members fitting between, and projecting beyond the ends of the outer plates of their respective structural sandwich plate members;

placing the structural sandwich plate members together so that the edges to be joined abutt, or nearly abutt; and

forming a weld between the outer plates of the two structural sandwich plate members.

The connecting member is preferably channel-shaped. The convex side of the connecting member projects from between the two outer plates. When the plate members abutt, the connecting member spaces apart the outer plates of the two plate members to allow a full thickness weld to be formed and acts as backing bar for that weld.

The invention also provides a structural sandwich plate member comprising:

two outer plates;

a core of plastics or polymer material bonded to the outer plates with sufficient strength to substantially contribute to the structural strength of the member; and

at least one connecting member fitted between, and projecting beyond the ends of said outer plates.

The materials, dimensions and general properties of the outer plates of the structural sandwich plate member of the invention may be chosen as desired for the particular use to which the structural sandwich plate member is to be put and in general may be as described in U.S. Pat. No. 5,778,813 and U.S. Pat. No. 6,050,208. Steel or stainless steel is commonly used in thicknesses of 0.5 to 20 mm and aluminium may be used where light weight is desirable. Similarly, the plastics or polymer core may be any suitable material, for example an elastomer such as polyurethane, as described in U.S. Pat. No. 5,778,813 and U.S. Pat. No. 6,050,208.

Lightweight forms may be included in the core, as described in WO 01/32414 and WO 02/078948. It should be noted that the lightweight forms serve to reduce the mass of the structural sandwich plate member and need not contribute significantly to its structural strength. The principal requirements on the lightweight forms are that they are of lower density than the plastics or polymer material forming the core and have sufficient thermal and mechanical properties to maintain the desired shape during injection and curing of the plastics or polymer core. The layout of the forms within the core may be as described in British Patent Application GB-2 389 072-A filed 29 May 2002.

The present invention will be described below with reference to an exemplary embodiment and the accompanying schematic drawings, in which:

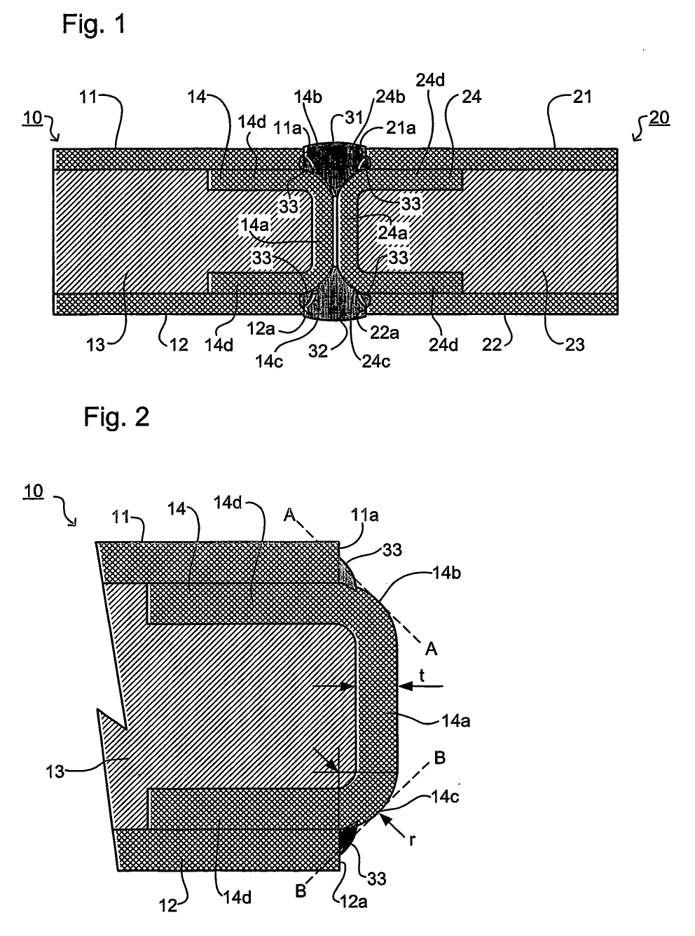

FIG. 1 is a cross-sectional view of parts of two structural sandwich plate members joined according to a first method of the present invention; and

FIG. 2 is an enlarged part cross-sectional view of a structural sandwich plate member according to the present invention.

In the various drawings, like parts are indicated by like reference numerals.

Each of the structural sandwich plate members 10, 20 shown in FIG. 1 comprises upper and lower outer plates (faceplates) 11, 12, 21, 22 which may be of steel and have a thickness of e.g. in the range of from 0.5 to 20 mm. Edge plates are welded between the faceplates 11, 12, 21, 22 around their outer peripheries to form a closed cavity. In the cavity between the faceplates 11, 12, 21, 22 is a core 13, 23 of compact (i.e. unfoamed) plastics or polymer material, preferably a polyurethane elastomer. This core may have a thickness in the range of from 15 to 200 mm. The core 13, 23 is bonded to the faceplates 11, 12, 21, 22 with sufficient strength and has sufficient mechanical properties to transfer shear forces expected in use between the two faceplates. The bond strength between the core 13, 23 and faceplates 11, 12, 21, 22 should be greater than 3MPa, preferably 6MPa, and the modulus of elasticity of the core material should be greater than 250 MPa. For low load applications, such as floor panels, where the typical use and occupancy loads are of the order of 1.4 kPa to 7.2 kPa, the bond strength may be lower, e.g. approximately 1 MPa. By virtue of the core layer, the structural sandwich plate member has a strength and load bearing capacity of a stiffened steel plate having a substantially greater plate thickness and significant additional stiffening.

To reduce the weight of the structural sandwich plate member 10, an array of lightweight forms may be provided, occupying a substantial part of the internal volume of the plate member. The lightweight forms do not need to significantly contribute to the structural strength of the plate and they require only to have thermal and mechanical properties sufficient to withstand the pressure of injection of the material to form core 13 and the heat from the exothermic reaction of the core during curing.

Along an edge at which one of the structural sandwich plate members is to be joined to another plate member of like type, the edge member takes the form of a channel section 14, 24 fitting between the faceplates 11, 12, 21, 22 with its concave side facing inward. The base portions 14a, 24a and corner portions 14b, 14c, 24b, 24c project outwardly of the ends 11a, 12a, 21a, 22a of the faceplates of the two structural sandwich plate members such that when two plate members are butted against each other, spaces are formed between the ends of the plate members 11a, 21a and 12a, 22a and bounded by the corner portions 14b, 24b and 14c, 24c. To join the two structural sandwich plate members 10, 20, a weld 31, 32 is formed in each of the spaces. A direct connection between the faceplates is thereby achieved quickly and simply. The corner portions 14b, c and 24b, c act as weld preparation for this weld.

FIG. 2 shows the position of the connecting member 14 in structural sandwich plate member 10 in more detail. As there shown, the connecting member 14 projects so that the tangents A-A, B-B to the corners 14b, 14c pass through the ends 11a, 12a of the faceplates 11, 12. This ensures that sufficient space is left between the faceplates of adjacent plate members to form a substantial weld whilst the corner portions 14b, 14c form weld preparations for the weld to join the faceplates. The radius of curvature, r, of the corner portions 14b, 14c is preferably equal to twice the thickness, t, of the metal plate from which the connecting member 14 is rolled. The thickness, t, will depend on the application to which the plates are to be put but will in general be comparable to the thickness of the faceplates 11, 12, e.g. 5 or 6 mm for shipbuilding applications.

The connecting member, if connected to the faceplates with sufficient strength, can contribute significantly to the strength of the plate member in the region of the join. This ensures that the plate member has sufficient strength even if the heat from the weld between the faceplates damages the elastomer core. In this case the connecting member can be welded to the faceplates with one pass seal welds 33.

If, in the final structure the connecting pieces 14, 24 do not need to carry loads between the structural sandwich plate members, they can be bonded to their respective plate members by the cores 13, 23. Thus, when the plate members are made, the connectors 14, 24 can be held in place by any simple convenient method, appropriate to the method of construction of the panels. For example, if the plate members are made in a mold, the clamping force of the mold bearing on the faceplates may be sufficient to hold the connecting members in place. Alternatively, a light adhesive, or a few spot welds may suffice. If the plate member is made using the faceplates to define the cavity for injection of the core, without a mold, the connecting members may be held in place with a shipbuilding adhesive or with light welds.

Manufacture of the plate members may be performed in situ, or off-site in factory conditions and the finished panel transported to the installation site.

It will be appreciated that the above description is not intended to be limiting and that other modifications and variations that fall within the scope of the present invention, which is defined by the appended claims, are possible.

1. A method of connecting two structural sandwich plate members each of which comprises two outer plates and a core of plastics or polymer material bonded to the outer plates with sufficient strength to transfer shear forces therebetween, the method comprising: providing in the edges of the structural sandwich plate members to be joined channel-shaped connecting members, the connecting members fitting between, and projecting beyond the ends of the outer plates of their respective structural sandwich plate members; placing the structural sandwich plate members together so that the edges to be joined abutt, or nearly abutt; and forming a weld between the outer plates of the two structural sandwich plate members.

2. A method according to claim 1 wherein said connecting members are channel-shaped.

3. A method according to claim 2 wherein in said step of providing, said connecting members are positioned so that the tangents to the corner thereof pass through the ends of said outer plates.

4. A method according to claim 1, 2 or 3 wherein in said step of providing, said connecting members are welded to said outer plates by a one-pass seal weld.

5. A method according to claim 1, 2 or 3 wherein the step of providing connecting members is performed at a different site than the steps of placing the structural sandwich plate members together and forming a weld.

6. A structural sandwich plate member comprising: two outer plates; a core of compact plastics or polymer material bonded to the outer plates with sufficient strength to substantially contribute to the structural strength of the member; and at least one connecting member fitted between, and projecting beyond the ends of said outer plates. said connecting member having surfaces adapted to be welded to a like connecting member in a like structural sandwich plate member.

7. A structural sandwich plate member according to claim 6 wherein said connecting member is channel-shaped.

8. A structural sandwich plate member according to claim 7 wherein tangents to the corners of said connecting members pass through the ends of said outer plates.

9. A structural sandwich plate member according to claim 6, 7 or 8 wherein the radius of curvature of the corners of said connecting member is at least twice the thickness of said connecting member.

10. A structural sandwich plate member according to claim 6, 7 or 8 wherein said connecting member is fixed to said outer plates by one-pass seal welds.

11. A structural sandwich plate member according to claim 6, 7, or 8 wherein said connecting member is formed from rolled metal.

12. A method according to claim 4 wherein the step of providing connecting members is performed at a different site than the steps of placing the structural sandwich plate members together and forming a weld.

13. A structural sandwich plate member according to claim 9 wherein said connecting member is fixed to said outer plates by one-pass seal welds.

14. A structural sandwich plate member according to claim 9 wherein said connecting member is formed from rolled metal.

15. A structural sandwich plate member according to claim 10 wherein said connecting member is formed from rolled metal.
